(19) United States
(12) Patent Application Publication
(10) Pub. No.: US 2021/0134256 A1
(43) Pub. Date: May 6, 2021

(54) MIDI EVENTS SYNCHRONIZATION SYSTEM, METHOD AND DEVICE

(71) Applicant: Innerclock Holdings Pty. Ltd., DEE WHY WEST (AU)

(72) Inventors: Warren MCALISTER, Katoomba (AU); David LACKEY, Dee Why West (AU); Jose ARJOL ACEBAL, Sha Tin (HK)

(21) Appl. No.: 17/084,925

(22) Filed: Oct. 30, 2020

Related U.S. Application Data
(60) Provisional application No. 62/929,177, filed on Nov. 1, 2019.

(51) Int. Cl. G10H 1/00

(52) U.S. Cl. CPC G10H 1/0066; G10H 2240/311; G10H 1/0025; G10H 1/0083

(57) ABSTRACT

A system including a method and device for real-time synchronization of MIDI generated sounds with audio program material originating from a Digital Audio Workstation (DAW). Provided is a real-time feed-forward control system for the generation of sound arising upon the execution of MIDI commands time-synchronized with the playback of audio program material. The system uses one or more audio synchronization tracks to accomplish synchronization. An audio interface device converts the data streams created by the playback of audio program tracks and audio synchronization tracks into electrical audio signals. The proposed MIDI interface device uses the audio synchronization signals output by the audio interface device to strobe or clock out MIDI events waiting on a FIFO buffer inside the device. Finally, the re-synchronized MIDI events are transmitted to the sound generating device in perfect synchronization with the audio program material.

### CROSS-REFERENCE TO RELATED APPLICATIONS

The present application claims priority to U.S. Provisional Application No. 62/929177, filed on Nov. 1, 2019.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates generally to the field of electronic music production systems, and more particularly, to MIDI interfaces.

### 2. Description of Related Art Including Information Disclosed Under 37 CFR 1.97 and 37 CFR 1.98.

In the past and present, music creation is produced by recording audio tracks and MIDI tracks in a software, Digital Audio Workstation (DAW), running on a computer platform. The audio tracks in the DAW transmit to an audio interface through a transmission interface, more particularly, a USB interface, but not limited to Network, Bluetooth, PCIE or Thunderbolt interfaces. Audio signals are then reproduced using a typical sound reproduction system comprising of a mixing console, amplifier and audio physical monitoring device such as loudspeakers and headphones. MIDI tracks in the DAW transmit to a MIDI interface through a transmission interface, more particularly, a USB interface, but not limited to Network, Bluetooth, PCIE or Thunderbolt interfaces. MIDI events are then generated and are sent to an electronic sound generating device. The audio output from the electronic sound generating device is reproduced by a typical sound reproduction system. The current systems do not account nor correct for timing differences between the USB-to-Audio interface and USB-to-MIDI interface.

At present, professional and amateur music studios, producers and engineers use multiple electronic sound generation devices to compose and record music, generally using the MIDI format. Recordings are made with DAW running on a computer platform. The electronic sound generation devices are a mix of designs made by different manufacturers. The electronic sound generation devices accept control signals subsequently derived from the MIDI events. Each of the electronic sound generation devices by different manufacturers carries its own response time errors (i.e. latency) due to limitations in the hardware and/or the design.

Similarly, the audio interfaces from various manufacturers carry their own latency due to design choices or limitations. Audio interfaces have varying size memory buffers, which also impact upon latency predictability.

Unknown latency results in poor time-alignment of MIDI generated sound and audio program material degrading the quality of real-time music creation. Consequently, there is a need in the art for synchronization of audio program material and MIDI generated sounds.

### BRIEF SUMMARY OF THE INVENTION

A system consisting of method and device for real-time synchronization of MIDI generated sounds with audio program material, consisting of the audio program tracks 201 and audio synchronization tracks 217, originating from a Digital Audio Workstation (DAW) 205. The present invention provides a real-time feed-forward control system for the generation of sound arising upon the execution of MIDI commands time-synchronized with the playback of audio program material. The system uses one or more audio synchronization tracks 219 to accomplish synchronization. An audio interface device 102 converts the data streams created by the playback of audio program tracks 201 and audio synchronization tracks 219 into electrical audio signals. The proposed MIDI interface device 103 uses the audio synchronization signals 219 output by the audio interface device 102 to strobe or clock out MIDI events 215 waiting on a FIFO buffer inside the device. Finally, the re-synchronized MIDI events 227 are transmitted to the sound generating device 104 in perfect synchronization with the audio program material.

### BRIEF DESCRIPTION OF THE SEVERAL VIEWS OF THE DRAWINGS

FIG. 1 is a schematic view of the complete system.

FIG. 2 is the system flow of the present invention.

### DETAILED DESCRIPTION OF THE INVENTION

In a first aspect, but not necessarily the broadest aspect, the present invention provides a system for real time synchronization of audio program material and MIDI generated sounds comprising:

a computer program for recording and playing a musical composition encoded as an audio program track and a MIDI track;

wherein an audio synchronization track carrying timing reference pulses is generated by the computer program;

an audio interface device for receiving a data stream comprising the audio program track and audio synchronization track by a data transmission interface;

wherein an audio program signal and an audio synchronization signal are extracted from the data stream by the audio interface device;

a MIDI interface device for receiving data stream of MIDI track by the data transmission interface;

wherein the MIDI track is parsed into a series of MIDI events and placed on a FIFO memory buffer; and

a synchronization engine in the MIDI interface device configured to trigger the hold or release of MIDI events from the FIFO memory buffer according to a synchronization algorithm;

wherein the synchronization algorithm is governed by timing reference pulses carried by the audio synchronization signal that is transmitted to the MIDI interface device by an audio connection.

In one embodiment of the first aspect, the computer program is configured to function as a DAW.

In one embodiment of the first aspect, the DAW is optional as an application software on a computer platform or a standalone hardware device.

In one embodiment ofthe first aspect, the data transmission interface is selected from a USB interface, a Network interface, a Bluetooth interface, a PCIE interface or a Thunderbolt interface.

In one embodiment of the first aspect, the audio program signal is encoded as an analog signal or a digital signal.

In one embodiment of the first aspect, the transmission of audio synchronization signal to the MIDI interface device is analog or alternatively a time-deterministic digital audio signal interface.

In one embodiment of the first aspect, the time-deterministic digital audio signal interface comprises SPDIF or AES/EBU.

In one embodiment of the first aspect, the system further comprising a sound generating device for receiving released MIDI events and a sound reproduction system for reproducing audio output from the sound generating device and audio program signal.

In one embodiment of the first aspect, the sound generating device is selected from a MIDI equipped electronic synthesizer, a drum machine, a sequencer, a rhythm machine, an audio sampler, and a DC pulse and analog control voltage sound generating device.

In one embodiment of the first aspect, the sound reproduction system comprises any one or more of a mixing console, an audio power amplifier and an audio physical monitoring device.

In a second aspect, but not necessarily the broadest aspect, the present invention provides a method for generating real time synchronization of audio program material and MIDI generated sounds comprising the steps of:

generating o f an audio synchronization track by a computer program for recording and playing a musical composition encoded as an audio program track and a MIDI track;

wherein the audio synchronization track carrying timing reference pulses recorded alongside an audio program track in the computer program;

transferring a data stream of the audio program track and the audio synchronization track to an audio interface device by a data transmission interface;

extracting an audio program signal and an audio synchronization signal from the data stream by the audio interface device;

wherein the audio synchronization signal are used to measure a cumulative delay or latency;

transferring data stream of a MIDI track in the computer program to a MIDI interface device by the data transmission interface;

parsing the MIDI data stream into a series of MIDI events;

placing the MIDI events on a FIFO memory buffer; and

triggering the hold or release of MIDI events from the FIFO memory buffer by a synchronization engine in the MIDI interface device;

wherein the trigger is according to a synchronization algorithm that is governed by the timing reference pulses carried by the audio synchronization signal that is transmitted to the MIDI interface device by an audio connection.

In one embodiment of the second aspect, the computer program is configured to function as a DAW.

In one embodiment of the second aspect, the DAW is optional as an application software on a computer platform or a standalone hardware device.

In one embodiment of the second aspect, the data transmission interface is selected from a USB interface, a Network interface, a Bluetooth interface, a PCIE or a Thunderbolt interface.

In one embodiment of the second aspect, the audio program signal is encoded as an analog signal or a digital signal.

In one embodiment of the second aspect, the transmission of audio synchronization signal to the MIDI interface device is analog or alternatively a time-deterministic digital audio signal interface.

In one embodiment of the second aspect, the time-deterministic digital audio signal interface comprises SPDIF or AES/EBU.

In one embodiment of the second aspect, the method further comprising the steps of receiving released MIDI events by a sound generating device and reproducing audio output from the sound generating device and the audio program signal by a sound reproducing system.

In one embodiment ofthe second aspect, the sound generating device is selected from a MIDI equipped electronic synthesizer, a drum machine, a sequencer, a rhythm machine, an audio sampler, and a DC pulse and analog control voltage sound generating device.

In one embodiment of the second aspect, the sound reproduction system comprises any one or more of a mixing console, an audio power amplifier, and an audio physical monitoring device.

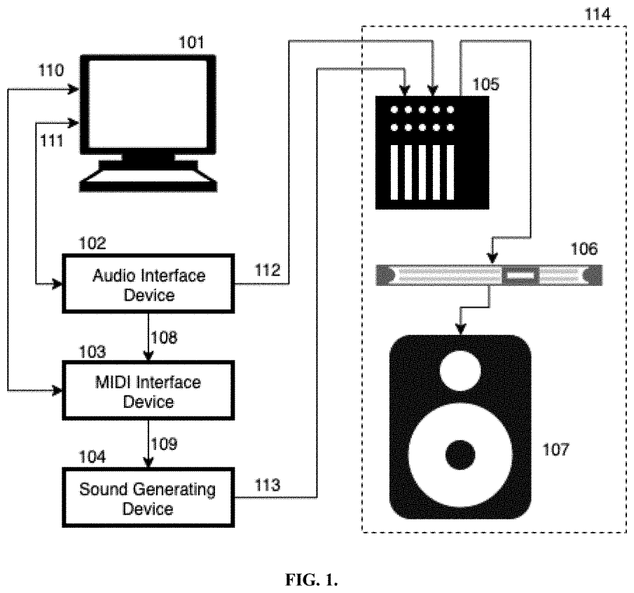

FIG.1 shows a schematic view of the functional components of the complete system of the present invention. Generally, music creation is produced by recording audio tracks 201 and music instrument digital interface (MIDI) tracks 203 in a software, Digital Audio Workstation (DAW) 205, running on a computer platform 101. A DAW 205 is a computer program for recording and playback of musical compositions consisting of audio program tracks 201 and MIDI tracks 203. The audio program tracks 201 in the DAW 205 transmit to an audio interface device 102 through a data transmission interface 111, more particularly, a USB interface, but not limited to Network, Bluetooth, PCIE or Thunderbolt interfaces. The audio interface device 102 converts USB digital audio data arising from the playback of audio program tracks 201 at the DAW 205 to analog or digital audio program signals 209. The DAW 205 can either be an application software running on a computer platform 101 or a standalone hardware device. Audio program signals 209 outputting from the audio interface device 102 are then reproduced using a typical sound reproduction system 114, usually comprising of, but not limited to a mixing console 105 for the combination of multiple audio signals 209, an audio power amplifier 106 and an audio physical monitoring device 107 such as loudspeakers and headphones through typical audio connection 112.

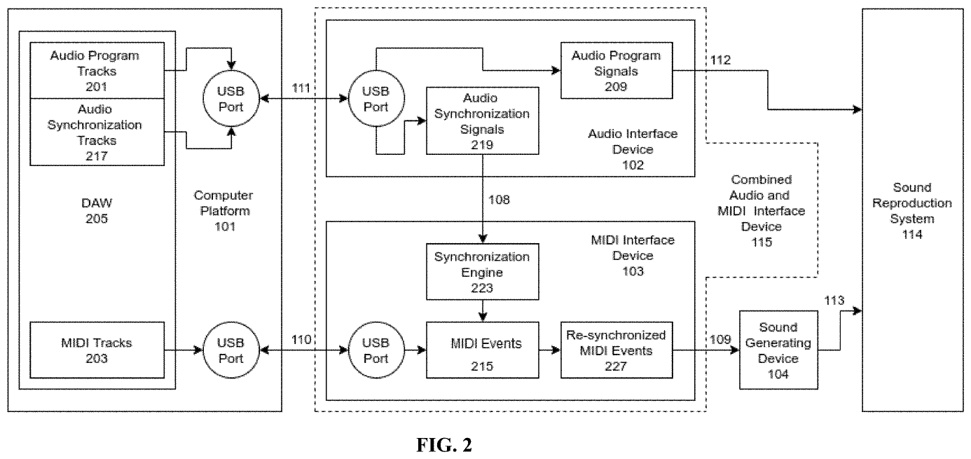

Referring to FIG. 2, MIDI tracks 203 in the DAW 205 transmit to a MIDI interface device 103 through a data transmission interface 110, more particularly, a USB interface, but not limited to Network, Bluetooth, PCIE or Thunderbolt interfaces. MIDI data streams arriving at the MIDI interface device 103 are then parsed into MIDI events 215 and placed on a FIFO memory buffer.

The present invention adds a synchronization engine 223 to a MIDI interface device 103. In the embodiment of FIG. 2, the MIDI interface device 103 is integrated with the audio interface device 102 into a single device 115. Where the system comprises a device having an integrated MIDI interface and audio interface, the connection 108 (which as described for other embodiments may be an analog signal cable, or alternatively a digital audio transmission interface such as SPDIF or AES/EBU) may have further variations. For example, where the integrated device 115 comprises two processors (one for handling MIDI signals and another for handling audio signals), use may be made of common inter-IC audio interfaces such as PDM, TDM, and I2S, other general purpose interfaces such as SPI or other digital synchronous inter-IC means for communication. Alternatively, where both MIDI and audio signals are processed by the same or within the same processor, the MIDI engine or subsystem within that IC may receive the audio synchronization signal or signals from the audio processing engine synchronized by way of, for example, the recovered audio master clock or audio word clock, or other audio subsystem clock or timer. It will be appreciated that integration of the MIDI interface device 103 is integrated with the audio interface device 102 is not essential to the present invention.

The synchronization engine 223 triggers the holding or releasing MIDI events 215 from a memory FIFO buffer according to a synchronization algorithm governed by the timing references pulses carried by the audio synchronization signals 219 and arriving at the MIDI interface device 103 by typical analog audio connection cables 108. Alternatively, time-deterministic digital audio signal interfaces such as SPDIF or AES/EBU may be used for connection. Then re-synchronized MIDI events 227 are then sent to an electronic sound generating device 104 including but not limited to MIDI equipped electronic synthesizers, drum machines, sequencers, rhythm machines, and samplers as well as DC pulse and analog control voltage sound generating devices. The audio output from the electronic sound generating device 104 is reproduced by the typical sound reproduction system 114 through typical audio connection 113.

The present invention provides a method of automatic calibration of data delivery to compensate for performance latency variations of external electronic sound generation devices 104. This method uses synchronization engine 223 to either advance or retard the releasing o f MIDI events 215 to sound generating devices 104, based on previously known or measured latencies for such different devices.

The present invention provides a DAW 205 plug-in computer program, which is responsible for the generation of the audio synchronization tracks 217. These audio synchronization tracks 217 carry timing reference pulses that are played by the DAW 205 alongside recorded audio program tracks 201. Both audio program tracks 201 and audio synchronization tracks 217 are transferred to an audio interface device 102 by a plurality of data transmission interfaces 111 such as USB, Network, Bluetooth, PCIE or Thunderbolt interfaces. Once the audio synchronization signals 219 within the audio interface device 102 are extracted from data streams coming from the data transmission interface 111, they have experienced the same delay or latency as the audio program signals 209, which followed the same signal flow. Therefore, the present invention utilizes the audio synchronization signals 219 have implicitly measured the cumulative delay or latency caused by the DAW 205, computer platform 101, its hardware and operating system, the data transmission interface 111, and the audio interface device 102. Finally, audio synchronization signals 219 are applied as the control signal to the synchronization engine 223 resulting in the feed-forward control method for real-time synchronization of MIDI generated sounds with audio program material herewith described.

From the foregoing, it will be appreciated that specific embodiments of the invention have been described herein for purposes of illustration, but that various modifications may be made without deviating from the scope of the invention.

We claim:

1. A system for real time synchronization of audio program material and MIDI generated sounds comprising:
a computer program for recording and playing a musical composition encoded as an audio program track and a MIDI track;
wherein an audio synchronization track carrying timing reference pulses is generated by the computer program;
an audio interface device for receiving a data stream comprising the audio program track and audio synchronization track by a data transmission interface;
wherein an audio program signal and an audio synchronization signal are extracted from the data stream by the audio interface device;
a MIDI interface device for receiving data stream of MIDI track by the data transmission interface;
wherein the MIDI track is parsed into a series of MIDI events and placed on a FIFO memory buffer; and
a synchronization engine in the MIDI interface device configured to trigger the hold or release of MIDI events from the FIFO memory buffer according to a synchronization algorithm;
wherein the synchronization algorithm is governed by timing reference pulses carried by the audio synchronization signal that is transmitted to the MIDI interface device by an audio connection.

2. The system according to claim 1, wherein the computer program is configured to function as a DAW.

3. The system according to claim 2, wherein the DAW is optional as an application software on a computer platform or a standalone hardware device.

4. The system according to claim 1, wherein the data transmission interface is selected from a USB interface, a Network interface, a Bluetooth interface, a PCIE interface or a Thunderbolt interface.

5. The system according to claim 1, wherein the audio program signal is encoded as an analog signal or a digital signal.

6. The system according to claim 1, wherein the transmission of audio synchronization signal to the MIDI interface device is analog or alternatively a time-deterministic digital audio signal interface.

7. The system according to claim 6, wherein the time-deterministic digital audio signal interface comprises SPDIF or AES/EBU.

8. The system according to claim 1, further comprising a sound generating device for receiving released MIDI events and a sound reproduction system for reproducing audio output from the sound generating device and audio program signal.

9. The system according to claim 8, wherein the sound generating device is selected from a MIDI equipped electronic synthesizer, a drum machine, a sequencer, a rhythm machine, an audio sampler, and a DC pulse and analog control voltage sound generating device.

10. The system according to claim 8, wherein the sound reproduction system comprises any one or more of a mixing console, an audio power amplifier and an audio physical monitoring device.

11. A method for generating real time synchronization of audio program material and MIDI generated sounds comprising the steps of:
generating o f an audio synchronization track by a computer program for recording and playing a musical composition encoded as an audio program track and a MIDI track;
wherein the audio synchronization track carrying timing reference pulses recorded alongside an audio program track in the computer program;
transferring a data stream of the audio program track and the audio synchronization track to an audio interface device by a data transmission interface;
extracting an audio program signal and an audio synchronization signal from the data stream by the audio interface device;
wherein the audio synchronization signal are used to measure a cumulative delay or latency;
transferring data stream of a MIDI track in the computer program to a MIDI interface device by the data transmission interface;
parsing the MIDI data stream into a series of MIDI events;
placing the MIDI events on a FIFO memory buffer; and
triggering the hold or release of MIDI events from the FIFO memory buffer by a synchronization engine in the MIDI interface device;
wherein the trigger is according to a synchronization algorithm that is governed by the timing reference pulses carried by the audio synchronization signal that is transmitted to the MIDI interface device by an audio connection.

12. The method according to claim 11, wherein the computer program is configured to function as a DAW.

13. The method according to claim 12, wherein the DAW is optional as an application software on a computer platform or a standalone hardware device.

14. The method according to claim 11, wherein the data transmission interface is selected from a USB interface, a Network interface, a Bluetooth interface, a PCIE or a Thunderbolt interface.

15. The method according to claim 11, wherein the audio program signal is encoded as an analog signal or a digital signal.

16. The method according to claim 11, wherein the transmission of audio synchronization signal to the MIDI interface device is analog or alternatively a time-deterministic digital audio signal interface.

17. The method according to claim 16, wherein the time-deterministic digital audio signal interface comprises SPDIF or AES/EBU.

18. The method according to claim 11, further comprising the steps of receiving released MIDI events by a sound generating device and reproducing audio output from the sound generating device and the audio program signal by a sound reproducing system.

19. The method according to claim 18, wherein the sound generating device is selected from a MIDI equipped electronic synthesizer, a drum machine, a sequencer, a rhythm machine, an audio sampler, and a DC pulse and analog control voltage sound generating device.

20. The method according to claim 18, wherein the sound reproduction system comprises any one or more of a mixing console, an audio power amplifier, and an audio physical monitoring device.
